(19) United States
(12) Patent Application Publication
(10) Pub. No.: US 2025/0131222 A1
(43) Pub. Date: Apr. 24, 2025

(54) IMAGE FORMING APPARATUS

(71) Applicant: CANON KABUSHIKI KAISHA, Tokyo (JP)

(72) Inventors: YUSUKE KURODA, Ibaraki (JP); SHOHEI OKUMURA, Tokyo (JP); HIROSHI TOMII, Chiba (JP)

(21) Appl. No.: 18/914,510

(22) Filed: Oct. 14, 2024

(30) Foreign Application Priority Data
Oct. 24, 2023 (JP) 2023-182530
Sep. 27, 2024 (JP) 2024-168109

(51) Int. Cl. G06K 15/02

(52) U.S. Cl. CPC G06K 15/1807; G06K 15/1836

(57) ABSTRACT

Disclosed is an image forming apparatus configured to form an image based on a first print job transmitted from a first type information processing device, and form an image based on a second print job transmitted from a second type information processing device different from the first type information processing device, the image forming apparatus includes a memory configured to store a plurality of print jobs including the first print job and the second print job and a controller configured to control the image forming apparatus to execute image formation based on the plurality of print jobs in an order stored in the memory, with the controller being configured to control whether to execute the image formation based on the selected print job.

### BACKGROUND

### Field

The present disclosure relates to an image forming apparatus, such as a printer, a copying machine, or a multifunction peripheral, which has an interrupt processing function for a print job.

### Description of the Related Art

An image forming apparatus that acquires a print job from an external apparatus to perform print processing stores and manages the acquired print job in a job queue. The image forming apparatus executes the print jobs stored in the job queue in order of acquisition. Hitherto, there has been known an image forming apparatus having an interrupt printing function of executing print jobs by causing a waiting print job to be interrupted by another new print job (Japanese Patent Application Laid-open No. 2022-26939).

Image forming apparatus have been expanded in various markets. For example, use of image forming apparatus has expanded in an office market in which the image forming apparatus are used by an indefinitely large number of users and in a commercial printing market in which the image forming apparatus are used to create publications. The image forming apparatus in the office market are used by an indefinitely large number of users. Thus, an interrupt printing function thereof may be used. The image forming apparatus in the commercial printing market have print jobs managed by administrators. The image forming apparatus that meet needs of both the office market and the commercial printing market support high image quality and high-speed processing of complex setting information for publications by attaching a dedicated controller to a related-art image forming apparatus for the office market.

The image forming apparatus may experience changes in image quality due to changes in conditions. In a case of using the interrupt printing function, an operation between an interrupting print job and an interrupted print job may cause changes in a charge amount of toner and resistance of an intermediate transfer belt, resulting in changes in image quality. However, the image forming apparatus that meet the needs of both the office market and the commercial printing market may execute both a print job in which changes in image quality are desired to be suppressed and a print job using a related-art interrupt printing function. In instances where a print job in which changes in image quality are desired is to be suppressed, another print job using the interrupt printing function may be executed, potentially making it difficult to maintain image quality. Thus, there has been a demand for an image forming apparatus that can maintain image quality even in a case of having the interrupt printing function.

### SUMMARY

An image forming apparatus according to the present disclosure is configured to form an image based on a first print job transmitted from a first type information processing device, and form an image based on a second print job transmitted from a second type information processing device different from the first type information processing device, the image forming apparatus includes a memory configured to store a plurality of print jobs including the first print job and the second print job and a controller configured to control the image forming apparatus to execute image formation based on the plurality of print jobs in an order stored in the memory, wherein the controller is configured to control, in a case where an instruction for executing image formation based on a selected print job, which is one of the first print job and the second print job, prior to image formation based on another print job is received, based on a type of an information processing device that has transmitted the another print job, whether to execute the image formation based on the selected print job.

Further features of the present disclosure will become apparent from the following description of exemplary embodiments, with reference to the attached drawings.

### BRIEF DESCRIPTION OF THE DRAWINGS

FIG. 1 is a diagram of an image forming system.

FIG. 2 is a flow chart for illustrating processing for a print job stored in a job queue.

FIG. 3 is a configuration diagram of an image forming apparatus.

FIG. 4 is an exemplary view of a main menu screen.

FIG. 5 is an exemplary view of a job queue screen.

FIG. 6 is an exemplary view of the job queue screen with a selected print job being highlighted.

FIG. 7 is a flow chart for illustrating determination processing for interrupt printing.

FIG. 8 is an exemplary view of an updated job queue screen.

FIG. 9 is an exemplary view of the job queue screen.

FIG. 10 is an exemplary view of the job queue screen displayed when a user is notified.

FIG. 11 is an exemplary view of a setting screen.

FIG. 12 is a diagram of an image forming system.

FIG. 13 is a flow chart for illustrating determination processing for interrupt printing.

FIG. 14 is an exemplary view of an interrupt request screen.

### DESCRIPTION OF THE EMBODIMENTS

Preferred embodiments of the present disclosure are described below with reference to the accompanying drawings. In the embodiments, a case in which an image forming apparatus is an electrophotographic color printer is described, but the image forming apparatus may be, for example, a copying machine, a facsimile machine, a multifunction machine, or a multifunction peripheral (MFP).

### First Embodiment

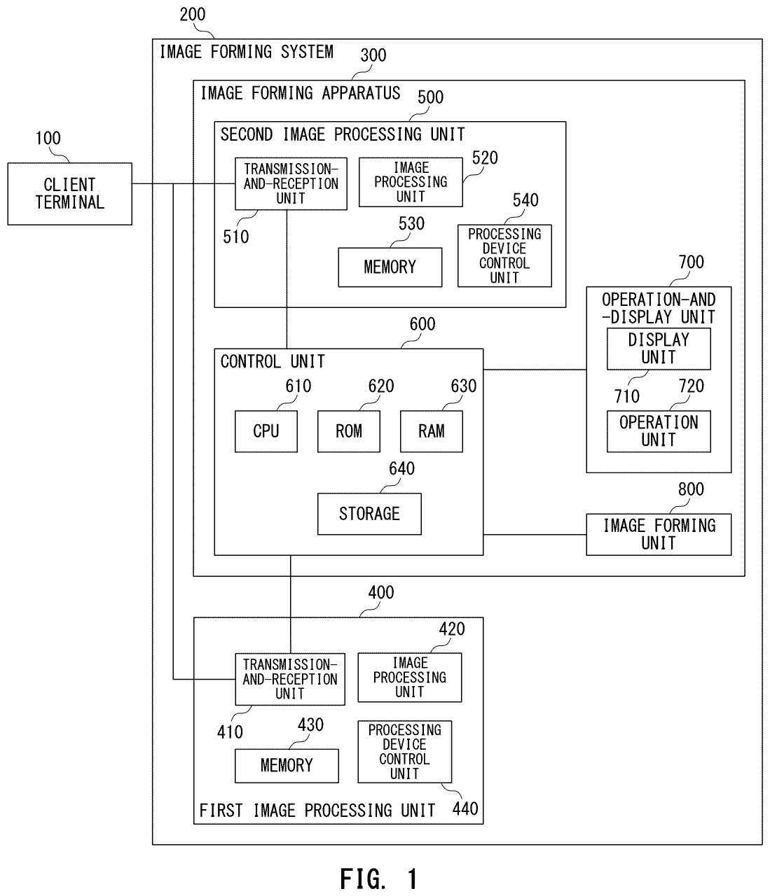

FIG. 1 is a diagram of an image forming system in a first embodiment of the present disclosure. An image forming system 200 includes an image forming apparatus 300 and a first image processing unit 400. The image forming apparatus 300 includes a second image processing unit 500, a control unit 600, an operation—and—display unit 700, and an image forming unit 800.

The image forming system 200 is connected to a client terminal 100, which is an external apparatus. The image forming system 200 acquires a print job from the client terminal 100. The print job is input to any one of the first image processing unit 400 and the second image processing unit 500. The first image processing unit 400 and the second image processing unit 500 perform different kinds of predetermined image processing for converting the acquired print job into printable image data. The image forming unit 800 prints an image on a sheet, which is an example of a recording medium, based on the image data.

The first image processing unit 400 functions as an external processing device for the image forming apparatus 300, and is referred to as “digital front end (DFE).” The first image processing unit 400 includes a transmission—and—reception unit 410, an image processing unit 420, a memory 430, and a processing device control unit 440. The second image processing unit 500 functions as an internal processing device for the image forming apparatus 300. The second image processing unit 500 includes a transmission—and—reception unit 510, an image processing unit 520, a memory 530, and a processing device control unit 540.

The first image processing unit 400 and the second image processing unit 500 acquire the print job from the external apparatus (client terminal 100) through the transmission—and—reception units 410 and 510. The print job includes page description language (PDL) data. The PDL data is a page description language that can be read by the image processing units 420 and 520, and includes image data and setting information set by a user. The setting information includes a type of a printer driver that has created the PDL data, a type of the image processing unit that is to perform processing (any one of the first image processing unit 400 and the second image processing unit 500), and a new interrupt printing determination flag that indicates whether or not the print job is an interrupt print job described later. The setting information also includes sheet settings, simplex or duplex printing, and a magnification.

The transmission—and—reception units 410 and 510 are connected to the external apparatus such as the client terminal 100 so as to enable communication therebetween through a network such as a local area network (LAN) or a connection interface such as a universal serial bus (USB). The client terminal 100 converts data on, for example, an image to be printed into PDL data through use of the printer driver, and transmits the PDL data to the image forming system 200.

The image processing units 420 and 520 perform raster image processor (RIP) processing for generating, from the PDL data, raster image data in which PDL data is expanded in a bitmap form. The raster image data is transmitted as the print job to the control unit 600 by the transmission—and—reception units 410 and 510 together with setting information and the type of the image processing unit that has performed the processing. The processing device control units 440 and 540 control operations of the first image processing unit 400 and the second image processing unit 500 by computer programs stored in the memories 430 and 530, respectively.

The first image processing unit 400 uses a dedicated memory to perform high-speed processing of complex setting information and large-volume print jobs. In a print job relating to image data input to the first image processing unit 400, for example, the user may select a resolution. The setting information of the print job includes user selection information regarding the resolution of an image to be formed. The resolution set in the print job can be selected by the user.

The second image processing unit 500 acquires simplified setting items from the client terminal 100, and thus uses simplified setting information to perform image processing while reducing a processing time. For example, a default resolution is set in a print job relating to image data input to the second image processing unit 500. The setting information of the print job includes no user selection information regarding the resolution of the image to be formed. The second image processing unit 500 is disposed inside the image forming apparatus 300, and thus serves as an embedded controller that supports space-saving requirements in an office market.

That is, the first image processing unit 400 performs image processing for mass printing with relatively high image quality for a commercial printing market, and the second image processing unit 500 performs image processing with relatively high productivity and a reduced processing time for the office market. Further, the number of types of setting information of print jobs to be transmitted by the first image processing unit 400 is greater than the number of types of setting information of print jobs to be transmitted by the second image processing unit 500.

In the first embodiment, the first image processing unit 400 is arranged outside the image forming apparatus 300, and the second image processing unit 500 is arranged inside the image forming apparatus 300, but the arrangement of the first image processing unit 400 and the second image processing unit 500 is not limited thereto. It suffices that two different image processing units are connected to the image forming apparatus 300. The image forming apparatus 300 forms an image based on a print job transmitted from the first image processing unit 400, and forms an image based on a print job transmitted from the second image processing unit 500. The first image processing unit 400 functions as an information processing device of a first type which performs image processing on image data of the print job, and the second image processing unit 500 functions as an information processing device of a second type which performs image processing based on image data of the print job.

The control unit 600 is connected to the first image processing unit 400, the second image processing unit 500, the operation—and—display unit 700, and the image forming unit 800. The control unit 600 can acquire a print job from each of the first image processing unit 400 and the second image processing unit 500, and causes the image forming unit 800 to form an image corresponding to the print job.

The control unit 600 includes a central processing unit (CPU) 610, a read only memory (ROM) 620, a random access memory (RAM) 630, and a storage 640. The storage 640 is a large-capacity storage device such as a hard disk drive (HDD) or a solid state drive (SSD). The CPU 610 controls an overall operation of the image forming apparatus 300 by executing computer programs stored in the ROM 620 and the storage 640. The RAM 630 provides a work area to be used in a case where the CPU 610 executes processing, and is used to, for example, store temporary data. The storage 640 is also used to store various kinds of data. For example, the storage 640 stores the print jobs (each including raster image data, setting information, and the like), which have been acquired from the first image processing unit 400 and the second image processing unit 500, in a job queue in order of acquisition.

The job queue stored in the storage 640 is described. The control unit 600 stores the print jobs, which have been acquired from the first image processing unit 400 and the second image processing unit 500, in the job queue in the storage 640, reads out the print jobs from the head in order of storage, and executes processing (image formation by the image forming apparatus 300). The job queue stores information such as the raster image data of each print job, the setting information, an order in which printing is to be executed, a job attribute described later, and a status of being in progress or waiting. In a case where the control unit 600 acquires a print job from each of the first image processing unit 400 and the second image processing unit 500, the control unit 600 adds the acquired print job to the end of the job queue.

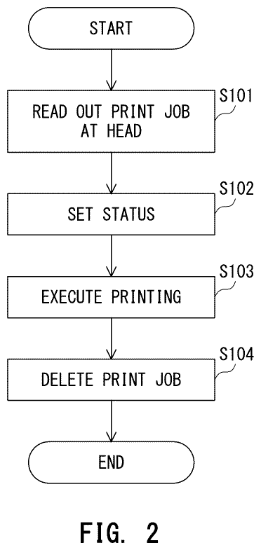

FIG. 2 is a flow chart for illustrating processing for a print job stored in the job queue. The control unit 600 reads out a print job at the head in the job queue (Step S101). The control unit 600 sets the status of the read-out print job to “in progress” (Step S102). At the same time, the control unit 600 instructs the image forming unit 800 to execute the print job (Step S103). This causes the image forming unit 800 to print an image corresponding to the print job on a sheet. In a case where the processing of the print job is finished, the control unit 600 deletes the print job from the job queue (Step S104).

The operation—and—display unit 700 is a user interface that combines a display unit 710 serving as an output interface and an operation unit 720 serving as an input interface with each other. The display unit 710 is formed of, for example, a flat panel display such as a liquid crystal display. Various setting screens and the like are displayed on the display unit 710 under the control of the control unit 600. The operation unit 720 is formed of a touch panel, key buttons, switches, and the like provided on the screen of the display unit 710. The operation unit 720 is operated by the user, and transmits received operation details to the control unit 600.

The user can input various instructions to the image forming apparatus 300 by performing operations through the operation unit 720 based on details of the screen displayed on the display unit 710. In the first embodiment, the user can issue, through the operation unit 720, instructions to display the job queue and to instruct interrupt printing.

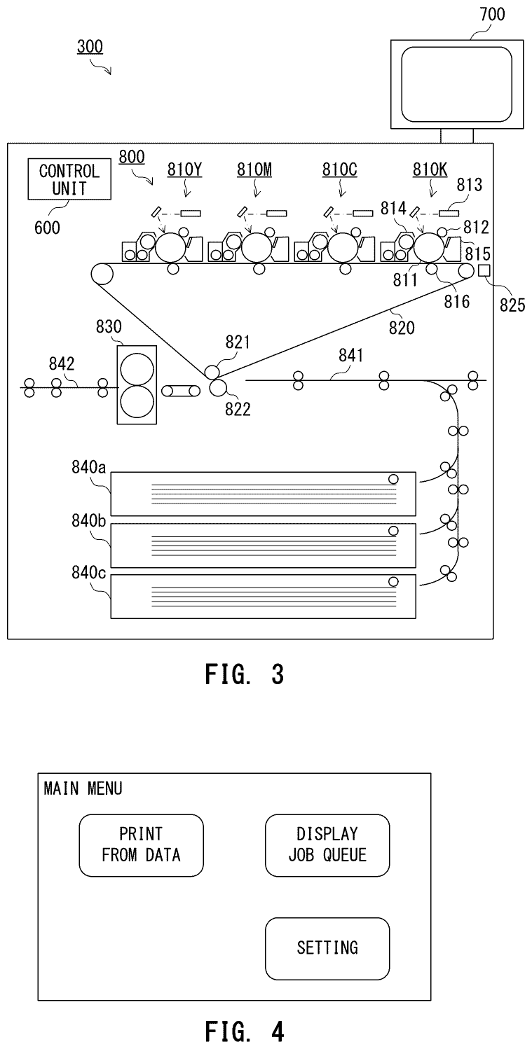

The image forming unit 800 prints an image corresponding to the print job on the sheet based on an execution instruction for the print job from the control unit 600. FIG. 3 is a configuration diagram of the image forming apparatus 300 including the image forming unit 800. The image forming apparatus 300 has the operation—and—display unit 700 provided above a casing, and has the control unit 600 and the image forming unit 800 provided inside. Although not shown in the figure, the second image processing unit 500 is also provided inside the image forming apparatus 300.

The image forming unit 800 includes a plurality of image forming portions for forming color images. In the first embodiment, four image forming portions 810Y, 810M, 810C, and 810K are provided in order to form images of four colors, yellow (Y), magenta (M), cyan (C), and black (K), respectively. The image forming unit 800 also includes an intermediate transfer belt 820, a secondary transfer inner roller 821, a secondary transfer roller 822, a fixing device 830, sheet feed cassettes 840a, 840b, and 840c, and conveyance paths 841 and 842.

The image forming portion 810Y is used to form a yellow image. The image forming portion 810M is used to form a magenta image. The image forming portion 810C is used to form a cyan image. The image forming portion 810K is used to form a black image. The image forming portions 810Y, 810M, 810C, and 810K have the same configuration and performs the same operation, except that the colors of the images to be formed are different. Here, the configuration and the operation of the image forming portion 810K are described.

The image forming portion 810K includes a photosensitive drum 811, a charging device 812, an exposure device 813, a developing device 814, a drum cleaner 815, and a primary transfer portion 816. The photosensitive drum 811 is a photosensitive member having a photosensitive layer on a surface thereof, and is rotated around a drum shaft. The charging device 812 uniformly charges the surface of the photosensitive drum 811 being rotated. The exposure device 813 irradiates the charged surface of the photosensitive drum 811 with a laser beam based on the raster image data (image data), to thereby form an electrostatic latent image on the surface of the photosensitive drum 811. The developing device 814 causes a developer (for example, toner) to adhere to the electrostatic latent image, to thereby form an image (toner image) on the surface of the photosensitive drum 811.

The primary transfer portion 816 is arranged at a position opposed to the photosensitive drum 811 with the intermediate transfer belt 820 interposed therebetween. The primary transfer portion 816 has a transfer bias applied thereto, to thereby transfer the image formed on the photosensitive drum 811 onto the intermediate transfer belt 820. Any toner remaining on the photosensitive drum 811 after the transfer is removed by the drum cleaner 815.

In the same manner, the images formed by the image forming portions 810Y, 810M, and 810C are also transferred onto the intermediate transfer belt 820. The intermediate transfer belt 820 is an endless belt stretched around a plurality of rollers including the secondary transfer inner roller 821, and is rotated in a direction from the image forming portion 810Y to the image forming portion 810K. The image forming portions 810Y, 810M, 810C, and 810K transfer the images in a superimposed manner in order from an upstream side in a rotation direction of the intermediate transfer belt 820. That is, the intermediate transfer belt 820 bears the images superimposed in the order of the yellow image, the magenta image, the cyan image, and the black image. The intermediate transfer belt 820 conveys the borne images to the secondary transfer inner roller 821 by being rotated.

Sheets are contained in the sheet feed cassettes 840a, 840b, and 840c. The sheet feed cassettes 840a, 840b, and 840c may contain the same type of sheets, or may contain different types of sheets. A sheet is fed from any one of the sheet feed cassettes 840a, 840b, and 840c to be conveyed to the secondary transfer roller 822 through the conveyance path 841.

The secondary transfer inner roller 821 and the secondary transfer roller 822 sandwich the intermediate transfer belt 820, thereby forming a secondary transfer portion. A sheet is conveyed to the secondary transfer portion in accordance with a timing at which the image borne on the intermediate transfer belt 820 is conveyed to the secondary transfer inner roller 821. The secondary transfer portion nips and conveys the sheet between the secondary transfer roller 822 and the intermediate transfer belt 820. At this time, the secondary transfer portion collectively transfers the images of all the colors on the intermediate transfer belt 820 onto the sheet by having a transfer bias applied to the secondary transfer roller 822.

The sheet onto which the images have been transferred is conveyed to the fixing device 830. The fixing device 830 fixes the images to the sheet by, for example, applying heat and pressure to the sheet. The sheet to which the images have been fixed is delivered outside the image forming apparatus 300 through the conveyance path 842.

An optical sensor 825 to be used for calibration of the image forming unit 800 is provided between the image forming portion 810K and the secondary transfer portion in the rotation direction of the intermediate transfer belt 820. The optical sensor 825 includes a light emitting element for emitting light toward a surface of the intermediate transfer belt 820 and a light receiving element for receiving reflected light from a measurement target on the intermediate transfer belt 820, and outputs a signal based on an amount of reflected light from the measurement target. In the calibration, the control unit 600 causes the image forming portions 810Y, 810M, 810C, and 810K to form a pattern image, and acquires the amount of reflected light from the pattern image by the optical sensor 825. Then, the control unit 600 obtains a density of the pattern image from the amount of reflected light, and controls image forming conditions for the image forming unit 800 based on the density of the pattern image so that the density of an image to be formed by the image forming portions 810Y, 810M, 810C, and 810K becomes a target density.

An operation to be performed by the image forming system 200 configured as described above at the time of executing a print job is described. The user uses the client terminal 100 to generate a print job including PDL data. The PDL data is generated by the printer driver converting an image to be printed.

The print job is transmitted from the client terminal 100 to the first image processing unit 400 or the second image processing unit 500 in accordance with the setting information. The PDL data included in the print job is converted into raster image data by being subjected to image processing including the RIP processing by the first image processing unit 400 or the second image processing unit 500. The raster image data is transmitted to the control unit 600 together with the setting information including information for identifying the image processing unit that has performed the image processing.

The control unit 600 assigns a job attribute described later to the acquired setting information. The control unit 600 stores the print job (raster image data and setting information) in the job queue. The control unit 600 causes the image forming unit 800 to print an image on a sheet based on the raster image data stored in the job queue.

### <Assignment of Job Attribute>

In the first embodiment, a print job that inhibits an interrupt or a print job that permits an interrupt is determined based on information included in the setting information. The information is information for identifying the image processing unit that has performed the image processing. A result of the determination is included in the setting information as a job attribute. The print job that inhibits an interrupt is assigned a job attribute being an interrupt inhibition attribute, and the print job that permits an interrupt is assigned a job attribute being an interrupt permission attribute.

A method of assigning a job attribute is described. In a case where the control unit 600 acquires raster image data and setting information from the first image processing unit 400 or the second image processing unit 500, the control unit 600 reads the type of the image processing unit (information for identifying the type of the information processing device that has performed the image processing) in the setting information. The control unit 600 uses the read type of the image processing unit to determine that the job attribute is the interrupt inhibition attribute in a case where the type is the first image processing unit 400 and determine that the job attribute is the interrupt permission attribute in a case where the type is the second image processing unit 500. The control unit 600 writes the determined job attribute into the setting information, and stores the raster image data and the setting information in the job queue. That is, the interrupt inhibition attribute is set in a print job processed by the first image processing unit 400 that performs image processing for producing image quality for the commercial printing market, and the interrupt permission attribute is set in a print job processed by the second image processing unit 500 that performs image processing for producing image quality for the office market.

### <Interrupt Printing>

In the first embodiment, in a case where the user instructs interrupt printing, the control unit 600 determines whether or not the interrupt printing is executable. The interrupt printing is a function of executing a newly created print job prior to a waiting print job, and is set by the user. In the first embodiment, in a case where a print job in the job queue is selected and the interrupt printing is instructed, the control unit 600 determines whether or not the interrupt printing is executable.

At the time of setting the interrupt printing, the operation—and—display unit 700 is used. The control unit 600 displays a main menu screen on the display unit 710 as an initial screen. FIG. 4 is an exemplary view of the main menu screen. On the main menu screen, a “DISPLAY JOB QUEUE” button, a “PRINT FROM DATA” button, and a “SETTING” button are displayed. When the user presses the “DISPLAY JOB QUEUE” button through the operation unit 720, the control unit 600 displays a job queue screen on the display unit 710.

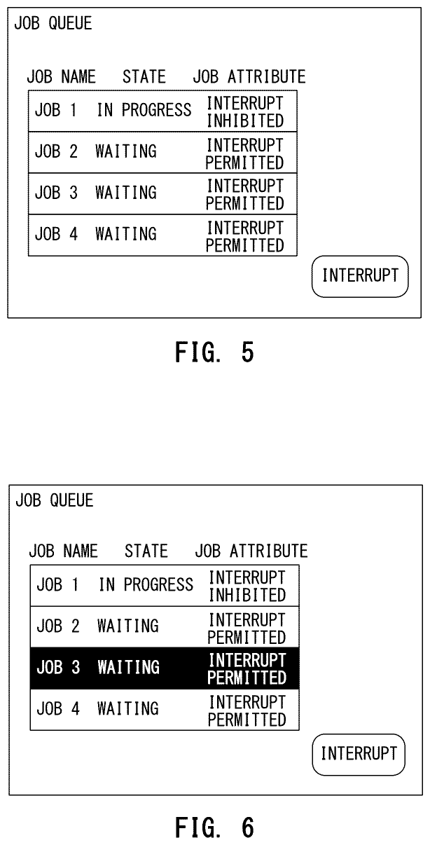

FIG. 5 is an exemplary view of the job queue screen. On the job queue screen, the setting information of each print job stored in the job queue and an “INTERRUPT” button are displayed. The setting information of the print job includes a name of the print job, a status (in progress or waiting) of the job, and the job attribute. On the job queue screen, print jobs are displayed so as to be arranged from top to bottom in order of execution of printing. The setting information of the print job is not limited thereto, and may include other information such as a time period required for printing or an estimated end time of printing.

In this case, the control unit 600 executes calibration each time 500 pages of images have been formed since the previous calibration was performed. On the job queue screen illustrated in FIG. 5, “JOB 1” is a print job that has been started when 200 pages of images have been formed since the previous calibration was performed. Further, the number of printed sheets for “JOB 1,” “JOB 2,” “JOB 3,” and “JOB 4” are all 50 pages.

The user can select a print job from the job queue screen through the operation unit 720. The print job selected by the user is highlight-displayed. FIG. 6 is an exemplary view of the job queue screen with “JOB 3” being highlight-displayed. In a case where the user selects “JOB 3” from the job queue screen of FIG. 5 through the operation unit 720, the job queue screen of FIG. 6 is displayed.

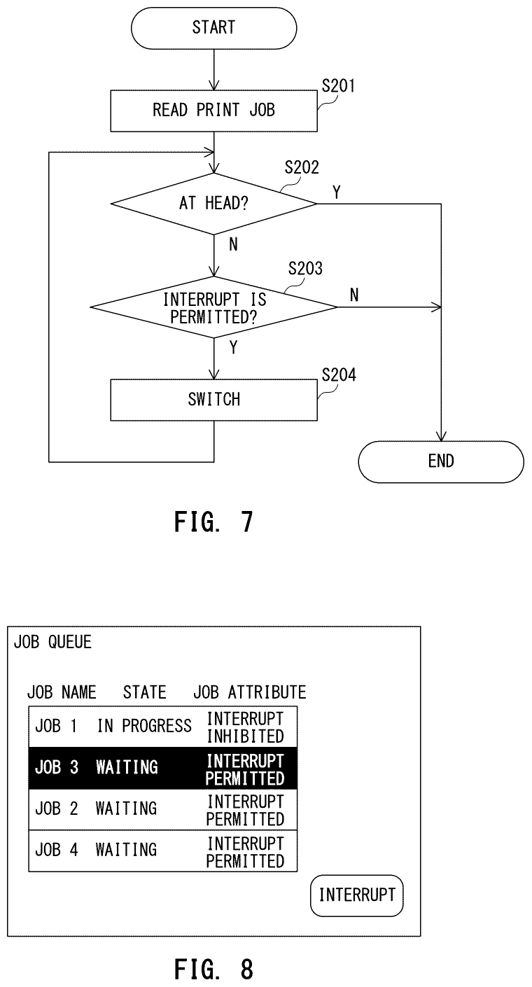

In a case where the user presses the “INTERRUPT” button after having selected a print job, the control unit 600 receives an instruction for executing image formation based on the selected print job prior to image formation based on another print job. This causes the control unit 600 to determine whether or not interrupt printing based on the selected print job is to be performed. FIG. 7 is a flow chart for illustrating determination processing for interrupt printing.

The control unit 600 reads each print job stored in the job queue (Step S201). The control unit 600 determines whether or not the selected print job is positioned at the head of the waiting print jobs (Step S202). In a case where the selected print job is at the head (Y in Step S202), the control unit 600 ends this processing.

In a case where the selected print job is not at the head (N in Step S202), the control unit 600 determines whether or not the job attribute of a print job immediately preceding the selected print job in the order of the job queue is interrupt-permitted (Step S203). In a case where the job attribute is not interrupt-permitted (N in Step S203), the control unit 600 ends this processing. In a case where the job attribute is interrupt-permitted (Y in Step S203), the control unit 600 switches positions of the selected print job and the print job immediately preceding the selected print job in the order of the job queue (Step S204). After completion of the switching of the positions in the order, the control unit 600 repeatedly performs the processing steps of Step S202 and the subsequent steps again. Those processing steps are repeatedly performed until the selected print job becomes the head of the waiting print jobs in the job queue among the waiting print jobs or the job attribute of the print job immediately preceding the selected print job in the order becomes interrupt-inhibited.

In a case where the determination processing of FIG. 7 is finished, the control unit 600 updates the job queue screen displayed on the display unit 710. That is, in a case where the “INTERRUPT” button is pressed on the screen of FIG. 6, the control unit 600 executes the processing of FIG. 7 to switch the positions of “JOB 3” and “JOB 2” in the order of the job queue. Thus, “JOB 3” becomes the head of the waiting print jobs in the job queue. In a case where the control unit 600 receives the instruction due to the pressing of the “INTERRUPT” button, in a case in which another print job has been transmitted from the second image processing unit 500 (information processing device of the second type), the control unit 600 causes the image formation based on the selected print job to be executed prior to the image formation based on the another print job. FIG. 8 is an exemplary view of the updated job queue screen.

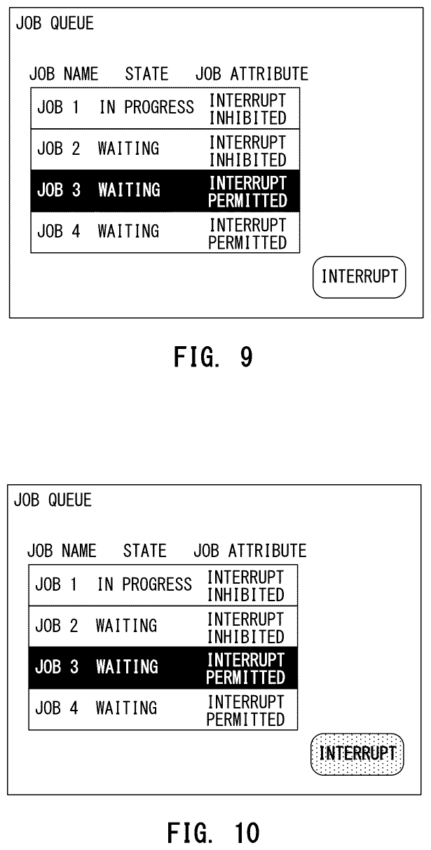

In the determination processing of FIG. 7, in a case where the print job immediately preceding the selected print job in the job queue has a job attribute indicating interrupt-inhibited, the switching of the positions of the print jobs in the order is not to be performed. FIG. 9 is an exemplary view of the job queue screen displayed in this case. In FIG. 9, the job attribute of “JOB 2” immediately preceding “JOB 3” is interrupt-inhibited. In a case where the control unit 600 receives the instruction due to the pressing of the “INTERRUPT” button, in a case in which another print job has been transmitted from the first image processing unit 400 (information processing device of the first type), the control unit 600 prevents the image formation based on the selected print job from being executed prior to the image formation based on the another print job. Thus, even in a case where the processing of FIG. 7 is performed, the switching of the positions in the order is not to be performed.

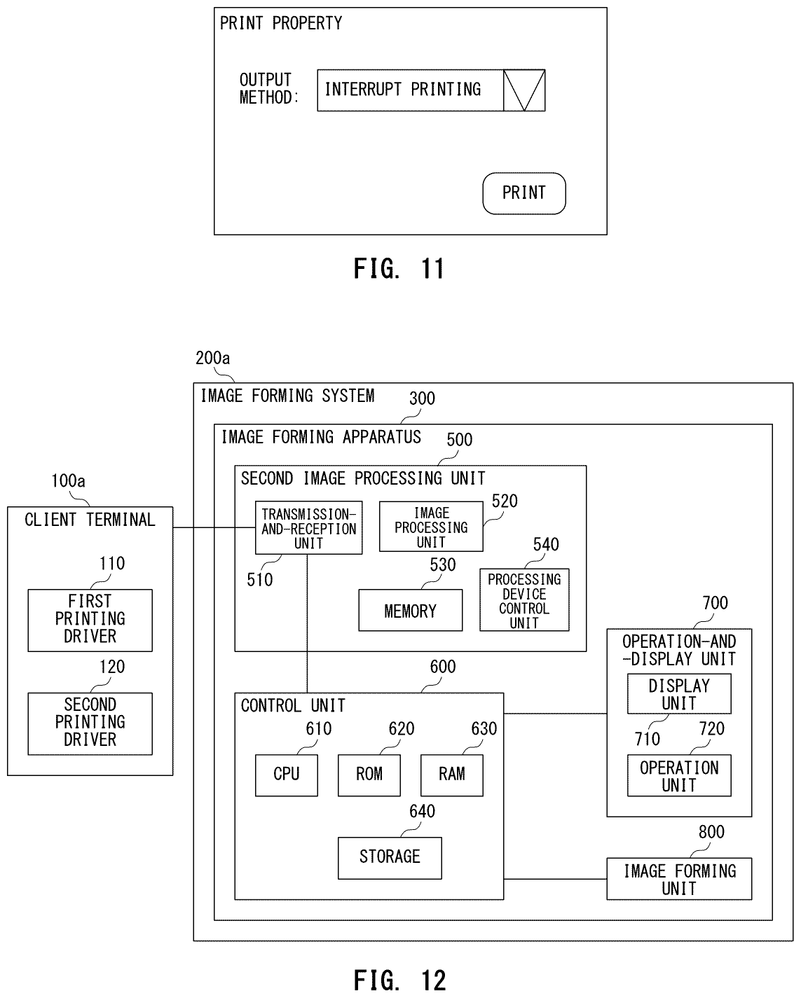

The determination processing of FIG. 7 is not limited thereto, and the determination for the interrupt processing may be performed based on the job attribute of the print job at the head in the job queue. In another case, the determination of the interrupt processing may be performed based on information other than the job attribute. Notification to the user is not limited to such job queue screens as illustrated in FIG. 8 and FIG. 9. FIG. 10 is another exemplary view of the job queue screen displayed in a case where the user is notified. The control unit 600 determines whether or not the interrupt printing is enabled under a state in which the user has selected a print job, and in a case where the interrupt printing is disabled, displays the job queue screen with the “INTERRUPT” button having been grayed out as illustrated in FIG. 10. This disables reception of an instruction to press the “INTERRUPT” button, and the user is notified that the interrupt printing is disabled.

### Second Embodiment

A configuration of the image forming system 200 in a second embodiment of the present disclosure is the same as that in the first embodiment. In the first embodiment, an instruction for the interrupt printing of a print job is issued through the operation—and—display unit 700, while in the second embodiment, an instruction for the interrupt printing is issued through the client terminal 100.

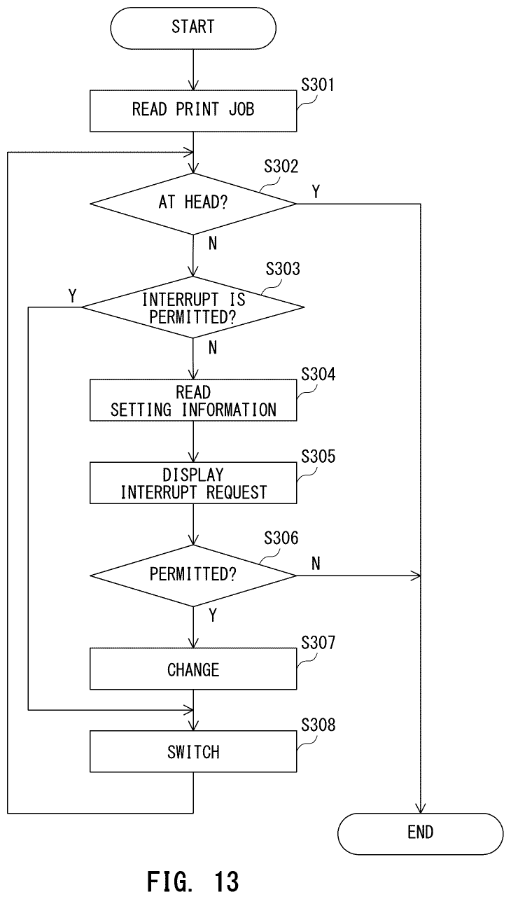

In a case where an instruction for the interrupt printing is issued through the client terminal 100, a setting screen for the interrupt printing is displayed on the display of the client terminal 100 by the printer driver of the client terminal 100. FIG. 11 is an exemplary view of such a setting screen. The user can issue an instruction for the interrupt printing from the setting screen through an input device of the client terminal 100.

At the time of creating PDL data, the printer driver can write information indicating details of the instruction for the interrupt printing into the setting information. In the second embodiment, the details of the instruction for the interrupt printing are represented by the new interrupt printing determination flag. In a case where the interrupt printing is instructed through the setting screen, the printer driver enables the new interrupt printing determination flag, and in a case where the interrupt printing is not instructed, disables the new interrupt printing determination flag. The new interrupt printing determination flag is included in the setting information of the print job. The print job including the PDL data and the setting information is transmitted from the client terminal 100 to the image forming system 200.

Any one of the first image processing unit 400 and the second image processing unit 500 receives the print job transmitted from the client terminal 100. The PDL data is subjected to the RIP processing by any one of the first image processing unit 400 and the second image processing unit 500 that has received the print job to be converted into raster image data. Information indicating the image processing unit that has performed the RIP processing is written into the setting information. The raster image data and the setting information with the information written therein are transmitted to the control unit 600.

The control unit 600 writes the job attribute into the acquired setting information. The control unit 600 stores the print job (including raster image data and setting information) in the job queue. At the time of storage in the job queue, the control unit 600 reads the new interrupt printing determination flag in the setting information.

In a case where the new interrupt printing determination flag is disabled, the control unit 600 stores the print job at the last position in the order of the job queue. In a case where the new interrupt printing determination flag is enabled, the control unit 600 stores the print job at the last position in the order of the job queue, and then performs the interrupt processing of FIG. 7. Thus, the print job for which the interrupt printing is instructed is stored at the head in the job queue or immediately after a print job that is interrupt-inhibited.

### Third Embodiment

FIG. 12 is a diagram of an image forming system in a third embodiment of the present disclosure. An image forming system 200a in the third embodiment has a configuration in which the first image processing unit 400 is removed from the image forming system 200 in the first embodiment of FIG. 1. A configuration of the image forming apparatus 300 is the same as that of the image forming apparatus 300 according to the first embodiment. The image forming system 200a can perform processing at the time of the interrupt printing in the same manner as in the first and second embodiments.

A client terminal 100a includes a first printer driver 110 and a second printer driver 120. The first printer driver 110 converts image data into PDL data described in PostScript (PS). The second printer driver 120 converts image data into PDL data described in Printer Control Language (PCL). The first printer driver 110 is used in the commercial printing market in which high image quality such as that of photographs is required, and is called “PS driver” or the like. The second printer driver 120 is a printer driver that is used to print text or drawings created by software for use in the office market in which high productivity is required, and is called “PCL driver” or the like. The first printer driver 110 and the second printer driver 120 are only required to differ in PDL format, and may each have a different PDL format.

The image forming system 200a may be connected to a plurality of client terminals 100 in the first embodiment. In this case, the plurality of client terminals 100 have mutually different printer drivers. That is, print jobs including PDL data generated in different PDL formats are input to the image forming system 200a.

An overall operation to be performed by the image forming system 200a at the time of executing a print job is described. The user generates a print job on the client terminal 100a. At this time, image data is converted into PDL data by any one of the first printer driver 110 and the second printer driver 120. The setting information of the print job includes a type of a printer driver that has generated the PDL data. The generated print job (including PDL data and setting information) is transmitted from the client terminal 100a to the second image processing unit 500 of the image forming system 200a.

The second image processing unit 500 performs the RIP processing on the PDL data included in the received print job to convert the PDL data into raster image data. The second image processing unit 500 transmits the raster image data and the setting information to the control unit 600.

The control unit 600 assigns the job attribute described later to the acquired setting information. The control unit 600 stores the print job (including raster image data and setting information) in the job queue. The control unit 600 causes the image forming unit 800 to print an image on a sheet based on the raster image data stored in the job queue.

### <Assignment of Job Attribute>

In the third embodiment, a print job that inhibits an interrupt or a print job that permits an interrupt is determined based on information on the printer driver that has created the PDL data. A result of the determination is included in the setting information as a job attribute. The print job that inhibits an interrupt is assigned a job attribute being an interrupt inhibition attribute, and the print job that permits an interrupt is assigned a job attribute being an interrupt permission attribute.

A method of assigning a job attribute is described. In a case where the control unit 600 acquires raster image data and setting information from the second image processing unit 500, the control unit 600 reads the type of the printer driver in the setting information. The control unit 600 uses the read type of the printer driver to determine that the job attribute is the interrupt inhibition attribute in a case where the type is the first printer driver 110 and to determine that the job attribute is the interrupt permission attribute in a case where the type is the second printer driver 120. That is, as to a print job that includes PDL data converted by the second printer driver 120, which is used for producing image quality for the office market, the interrupt permission attribute is set. As to a print job that includes PDL data converted by the first printer driver 110, which is used for producing image quality for the commercial printing market, the interrupt inhibition attribute is set. The control unit 600 writes the determined job attribute into the setting information, and stores the raster image data and the setting information in the job queue. Accordingly, in the same manner as in the first and second embodiments, it is possible to determine whether or not the interrupt printing is enabled based on the job attribute.

### Fourth Embodiment

In a fourth embodiment of the present disclosure, a request function for the user to request interrupt permission in a case where the interrupt printing is inhibited by the job attribute is added. A configuration in which an interrupt request is always possible is described. A configuration of the image forming system may be any one of the configuration of that in the first and second embodiments and the configuration of that in the third embodiment. Now, a case of using the configuration of the image forming system 200 in the first and second embodiments is described. FIG. 13 is a flow chart for illustrating determination processing for the interrupt printing.

The control unit 600 reads each print job stored in the job queue (Step S301). The control unit 600 determines whether or not the selected print job is positioned at the head of the waiting print jobs (Step S302). In a case where the selected print job is at the head (Y in Step S302), the control unit 600 ends this processing.

In a case where the selected print job is not at the head (N in Step S302), the control unit 600 determines whether or not the job attribute of a print job immediately preceding the selected print job in the order of the job queue is interrupt-permitted (Step S303). In a case where the job attribute is interrupt-permitted (Y in Step S303), the control unit 600 switches positions of the selected print job and the print job immediately preceding the selected print job in the order of the job queue (Step S308). After the switching of the positions in the order is finished, the control unit 600 repeatedly performs the processing steps of Step S302 and the subsequent steps again.

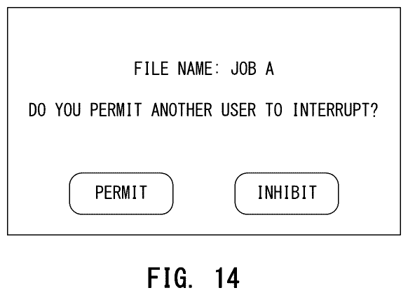

In a case where the job attribute is not interrupt-permitted (N in Step S303), the control unit 600 reads the setting information of the print job immediately preceding the selected print job from the job queue (Step S304). The setting information includes a print job name of the immediately preceding print job, user information of a user who has generated the print job, and a name of a client terminal that has generated the print job. The control unit 600 uses the read setting information to communicate to/from the client terminal that has generated the print information, and causes the client terminal to display an interrupt request screen (Step S305). FIG. 14 is an exemplary view of the interrupt request screen.

The user who has generated the print job instructs to permit or inhibit the interrupt printing from the interrupt request screen. Details of the instruction are transmitted from the client terminal to the control unit 600. The control unit 600 identifies the details of the instruction (Step S306). In a case where the details of the instruction are to permit the interrupt printing (Y in Step S306), the control unit 600 changes the job attribute of the print job to interrupt-permitted (Step S307). After that, the control unit 600 performs the processing step of Step S308. In a case where the details of the instruction are to inhibit the interrupt printing (N in Step S306), the control unit 600 ends this processing.

This processing may be performed only when the user specifies that the user wishes to make an interrupt request at the time of generating a print job. In another case, the interrupt request screen may be displayed on the client terminal after the processing of FIG. 7, and the processing steps of Step S305 and the subsequent steps may be performed.

In each of the embodiments described above, permission or inhibition of the interrupt printing is set in each print job of a plurality of print jobs that are included in a job queue. In a case where another print job for which the interrupt printing is instructed is input, the order of the print jobs included in the job queue is set again based on the setting information of each print job in the job queue. That is, another print job for which the interrupt printing is instructed is prevented from interrupting a print job in which interrupt printing therebefore is inhibited. This prevents another print job from being performed before a print job in which interrupt printing therebefore is inhibited, thereby being able to suppress changes in image quality due to interrupt printing.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-182530, filed Oct. 24, 2023 and No. 2024-168109, filed Sep. 27, 2024, which are hereby incorporated by reference herein in their entirety.

What is claimed is:

1. An image forming apparatus configured to form an image based on a first print job transmitted from a first type information processing device, and form an image based on a second print job transmitted from a second type information processing device different from the first type information processing device, the image forming apparatus comprising:
a memory configured to store a plurality of print jobs including the first print job and the second print job; and
a controller configured to control the image forming apparatus to execute image formation based on the plurality of print jobs in an order stored in the memory,
wherein the controller is configured to control, in a case where an instruction for executing image formation based on a selected print job, which is one of the first print job and the second print job, prior to image formation based on another print job is received, based on a type of an information processing device that has transmitted the another print job, whether to execute the image formation based on the selected print job.

2. The image forming apparatus according to claim 1,
wherein the controller is further configured to prevent, in a case where the instruction is received and the another print job has been transmitted from the first type information processing device, the image formation based on the selected print job from being executed prior to the image formation based on the another print job.

3. The image forming apparatus according to claim 1,
wherein the controller is further configured to permit, in a case where the instruction is received and the another print job has been transmitted from the second type information processing device, the image formation based on the selected print job to be executed prior to the image formation based on the another print job.

4. The image forming apparatus according to claim 1,
wherein the first type information processing device comprises an image processing unit configured to output raster image data by performing image processing on image data generated through use of a first type printer driver, and
wherein the second type information processing device comprises an image processing unit configured to output the raster image data by performing image processing on image data generated through use of a second type printer driver that is different from the first type printer driver.

5. The image forming apparatus according to claim 1,
wherein a number of types of information included in the first print job transmitted from the first type information processing device is greater than a number of types of information included in the second print job transmitted from the second type information processing device.

6. The image forming apparatus according to claim 1,
wherein the first type information processing device is configured to transmit a print job including user selection information regarding a resolution of an image to be formed, and
wherein the second type information processing device is configured to transmit a print job that does not include any user selection information regarding the resolution of the image to be formed.

7. The image forming apparatus according to claim 1, further comprising an operation unit for inputting the instruction.

8. The image forming apparatus according to claim 1, further comprising a display unit configured to display the plurality of print jobs stored in the memory such that the plurality of print jobs are arranged in order of execution of the image formation.
